(19) United States
(12) Patent Application Publication
(10) Pub. No.: US 2006/0284891 A1
(43) Pub. Date: Dec. 21, 2006

(54) Method for spatial up-scaling of video frames

(75) Inventors: Ihor Kirenko, Eindhoven (NL); Taras Telyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/569,716

(22) PCT Filed: Aug. 19, 2004
(86) PCT No.: PCT/IB04/02698

§ 371 Date: Feb. 24, 2006

(30) Foreign Application Priority Data
Aug. 28, 2003 (EP) 03300097.7

(51) Int. Cl. G09G 5/00

(52) U.S. Cl. 345/660

(57) ABSTRACT

The present invention relates to method for spatial up-scaling of an original video frame comprising p rows and q colums of pixels, where p and q are integers. Said up-scaling method comprises a step of constructing high-low (HL), low-high (LH), and high-high (HH) virtual spatial frequency subbands comprising p rows and q colums of pixels from the use of high-pass filtering of the original video frame, considered as a low-low spatial frequency subband (LL), in horizontal, vertical, and both directions, respectively. Said up-scaling method further comprises a step of applying an inverse wavelet transform (IWT) to the constructed subbands and to the original video frame in such a way that an up-sampled version of the original image is obtained.

### FIELD OF THE INVENTION

The present invention relates to a method and device for spatial up-scaling of an original video frame comprising p rows and q colums of pixels, where p and q are integers.

It relates to a computer program product comprising program instructions for implementing said up-scaling method.

This invention is, for example, relevant for television receivers or for personal computers, which have to be able to display still images or sequence of images at different scales.

### BACKGROUND OF THE INVENTION

The development of high-resolution displays requires the use of efficient methods for spatial up-scaling of still images or sequence of images. Conventional methods of up-scaling include duplicating pixels and lines, exploitation of bilinear interpolation or other averaging techniques. However, these techniques result in poor quality of up-scaled images due to appearance of rough contours. Even if separable polyphase up-conversion filters are used, the problem of jagged lines remains.

Other up-scaling methods use a discrete wavelet transform in a way similar to wavelet-based compression algorithms. The idea is based on the fact that a forward wavelet transform of an original image results in a low-low LL subband, which comprises low-frequency information in both horizontal and vertical directions and which is a downscaled version by a factor of 2 of said original image. On the contrary, if an original image is considered as a low-low subband received after a forward wavelet transform, then said original image may be up-scaled by applying an inverse wavelet transform. But the high-frequency subbands (i.e. the high-low HL, low-high LH, and high-high HH subbands), corresponding to the low-low subband LL (i.e. the original image) have to be constructed in order to apply the inverse wavelet transform.

The U.S. Pat. No. 6,377,280 proposes an up-scaling method comprising a step of constructing these virtual high-frequency subbands HL, LH, and HH. According to said method, the original image is forward wavelet transformed to obtain HL1, LH1, HH1 subbands of a first decomposition level. Then, values of the wavelet coefficients from subbands HL1 and LH1, are fetched to the virtual subbands HL and LH, respectively. Because the number of wavelet coefficients in subbands HL1 or LH1 is four times smaller than in virtual subbands HL or LH, the rest of coefficients in HL and LH subbands are set to zero according to a predetermined pattern. This prior art method is based on the assumption that wavelet coefficients at different decomposition levels are very similar in both amplitude and sign. However, this is not always true and the relocation of coefficients from one subband of a predetermined level, e.g. HL1, into another subband of a level lower than said predetermined level, e.g. HL, does not always provide a high picture quality. Moreover, this up-scaling method is rather complex and requires quite heavy computational resources.

### SUMMARY OF THE INVENTION

It is an object of the invention to propose an up-scaling method, which is less complex than the one of the prior art.

To this end, the up-scaling method in accordance with the invention is characterized in that it comprises the steps of:

high-pass filtering the original video frame, considered as a low-low spatial frequency subband, in horizontal, vertical, and both directions, to construct high-low, low-high, and high-high virtual spatial frequency subbands comprising p rows and q colums of pixels, respectively,

applying an inverse wavelet transform to the constructed subbands and to the original video frame so that an up-sampled version of the original image is obtained.

As a consequence, the generated virtual spatial frequency subbands have the same size as the original video frame. Thus, the up-scaling method in accordance with the invention does not need an additional step of combining a virtual spatial frequency subband of a first decomposition level, having size p/2*q/2, with null coefficients in order to obtain a virtual spatial frequency subband comprising p rows and q colums of data, as done in the prior art method.

Moreover, by a proper choice of the high-pass filters, the picture quality is improved. This is for example the case if the high-pass filter is chosen among the same wavelet filters family than the filters used for the inverse wavelet transform.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawing, wherein:

FIG. 1 is a block diagram of an up-scaling method in accordance with the invention,

FIG. 2 is a block diagram of a conventional two-dimensional inverse wavelet transform,

FIG. 3A is a block diagram of a conventional lifting scheme, and

FIG. 3B is a block diagram of a simplified lifting scheme.

### DETAILED DESCRIPTION OF THE INVENTION

The present invention relates to a method and device for spatial up-scaling of still images or of sequences of video images.

The invention is based on the application of an inverse discrete wavelet transform (IWT) to the original image, considering said image as a low-low LL subband, and to the corresponding high-frequency subbands, which are efficiently predicted based on the original image information. The ability of a discrete wavelet transform to perform high quality approximation of edge features of an image makes it ideal for up-sampling applications.

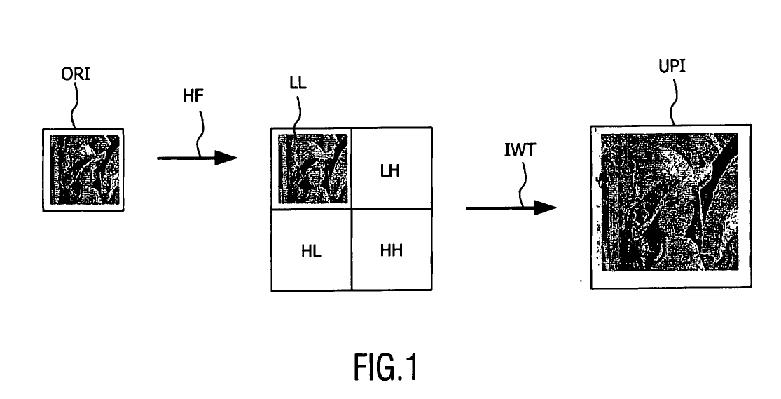

FIG. 1 illustrates the general principle of the up-scaling method in accordance with the invention.

At the first step of said method, the original image ORI, which comprises p rows and q columns of pixels, is considered as a virtual low-low LL subband received after a discrete forward wavelet transform of a virtual up-scaled image.

After that, the high-frequency spatial subbands (i.e. low-high LH, high-low HL, and high-high HH) are constructed from the original image considered as the low-low LL subband using a high-pass filtering HF. The low-high LH subband contains information about horizontal edges in the original image; the high-low HL subband contains information about vertical edges, and the high-high HH subband contains information about diagonal edges.

At a final stage, the proposed up-scaling method comprises a two-dimensional discrete inverse wavelet transform IWT, which is applied to the original image and to the constructed high-frequency subbands in order to obtain and transmit an up-scaled image UPI, with the number of rows and columns of pixels twice larger than in the original image, i.e. 2p rows and 2q columns of pixels.

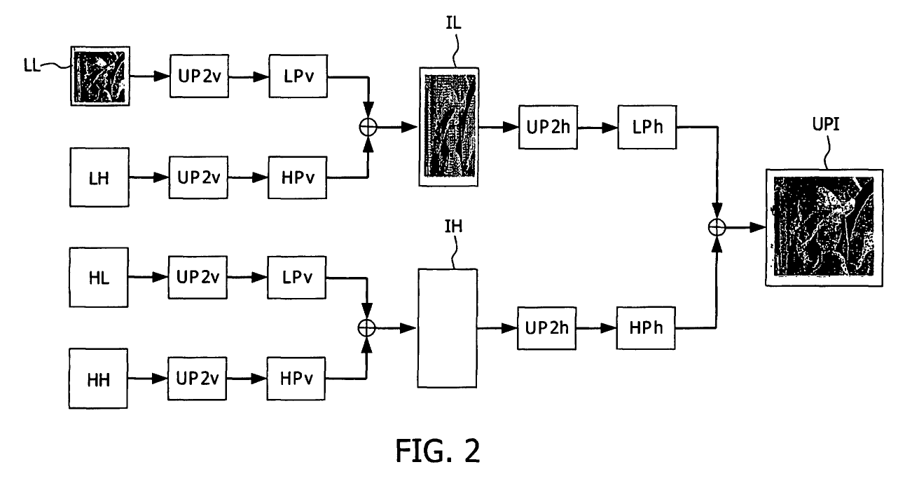

FIG. 2 illustrates said two-dimensional inverse wavelet transform. Said inverse wavelet transform comprises a first step UP2v of up-sampling by 2 along a vertical y-direction the different subbands LL, LH, HL and HH. Then, it comprises a step LPv of low-pass filtering the up-sampled LL and HL subbands using a low-pass filter LP in a vertical direction. It also comprises a step HPv of high-pass filtering the up-sampled LH and HH subbands using a high-pass filter HP in a vertical direction. Then, the low-pass-filtered and up-sampled LL subband and the high-pass-filtered and up-sampled LH subband are added, resulting in an intermediate low-frequency frame IL comprising 2p*q pixels. The low-pass-filtered and up-sampled HL subband and the high-pass-filtered and up-sampled HH subband are also added, resulting in an intermediate high-frequency frame IH comprising 2p*q pixels.

The inverse wavelet transform comprises a second step UP2h of up-sampling by 2 along a horizontal x-direction the intermediate frames IL and IH. Then, it comprises a step LPh of low-pass filtering the up-sampled IL frame using the low-pass filter LP in a horizontal direction. It also comprises a step HPh of high-pass filtering the up-sampled IH frame using the high-pass filter HP in a horizontal direction. Then, the low-pass-filtered and up-sampled IL frame and the high-pass-filtered and up-sampled IH frame are added, resulting in the up-scaled image UPI comprising 2p*2q pixels.

As an example, the low-pass filter is LP1=½ [1, 1] and the high-pass filter is HP1=½ [1, −1]. In other words, when the low-pass filter LP is applied in the horizontal x-direction to a pixel m, we have:
LP1(m)=(x(m)+x(m+1))/2,

and when applied in the vertical y-direction to a pixel n, we have:
LP1(n)=(y(n)+y(n+1))/2.

In the same manner, when the high-pass filter HP is applied in the horizontal x-direction to a pixel m, we have:
HP1(m)=(x(m)−x(m+1))/2

and when applied in the vertical y-direction to a pixel n, we have:
HP1(n)=(y(n)−y(n+1))/2.

It will be apparent to a person skilled in the art that the present invention is not limited to this pair of filters and that other pairs of filters are applicable, such as for example, LP2=[0.02674875967204570800; −0.01686411909759044600; −0.07822325080633163500; 0.26686409115791321000; 0.60294902324676514000; 0.26686409115791321000; −0.07822325080633163500; −0.01686411909759044600; 0.02674875967204570800] and HP2=[0.045635882765054703, −0.028771763667464256, −0.2956358790397644, 0.5574351615905762, −0.2956358790397644, −0.028771763667464256, 0.045635882765054703] proposed by Antonini et al. in the paper entitled “Image Coding Using Wavelet Transform” IEEE Trans. Image Processing, vol. 1, no. 2, pp. 205-220, April 1992.

The present invention proposes to construct coefficients of the virtual high-frequency subbands HL, LH and HH from the low-low LL subband using a high-pass filter. Said high-pass filter HP is applied to the original frame, i.e. the Lt subband, in the horizontal direction, in the vertical direction and in both directions, in order to obtain the HL, LH, and HH subbands, respectively.

According to an embodiment of the invention, the high-pass filter HP is chosen among the same wavelet filters family than the filters used for the inverse wavelet transform. This provides an almost optimal combination with the inverse wavelet transform.

As an example, the high-pass filter HP used for the construction step is the same as the high-pass filter HPf of a forward wavelet transform corresponding to the inverse wavelet transform used in the up-scaling method in accordance with the invention. More precisely, if LPf and HPf are the low-pass and high-pass filters of the forward wavelet transform, and LPi and HPi are the low-pass and high-pass filters of the inverse wavelet transform, then their relationships in the frequency domain are the following:
LPi(ω)=HPf(ω+π)

HPi(ω)=−LPf(ω+π), where ω is the frequency.

Their relationships in the spatial domain is:
HPf(k)=−(−1)^{k}.LPi(k)

HPi(k)=(−1)^{k}.LPf(k) where k is an integer comprised between −K and K, K having a predetermined value.

For example, if the inverse wavelet transform filters are LPi=¼ [1, 2, 1] and HPi=¼ [1, 2, −6, 2, 1], then the high-pass filter used for the construction of the HL, LH, and HH subbands is HP=HPf=¼ [1, −2, 1].

Thus, the proposed method does not require a complete forward wavelet transform but only a simplified version of said wavelet transform. At the same time, it allows a better reflection of high-frequency information of the original image because it does not exploit operation of down-sampling required for forward wavelet transform or does not copy information from subbands of a predetermined level into subbands of a level lower than said predetermined level. The simplified wavelet transform used for the subband prediction involves only a high-pass filtering in one or both directions, without low-pass filtering and down-sampling of wavelet coefficients, which are otherwise required by a conventional forward wavelet transform.

Each of the high-frequency subbands is constructed by applying this high-pass filter to the low-low LL subband, i.e. the original image, in a horizontal direction, in a vertical direction, or in both directions. In order to receive the low-high LH subband, the original image is high-pass filtered in the vertical direction; thus horizontal edges are preserved. The high-low HL subband is constructed by high-pass filtering the original image in the horizontal direction. The high-high HH subband is constructed by applying the high-pass filter in both horizontal and vertical directions. Alternatively, this high-high HH subband is constructed by applying a null filter to the original image, resulting in a HH subband filled with zeros. Such an alternative solution enables to save computational resources. The result of the high-pass filtering is that the size of the constructed subbands is then equal to the size of the original image.

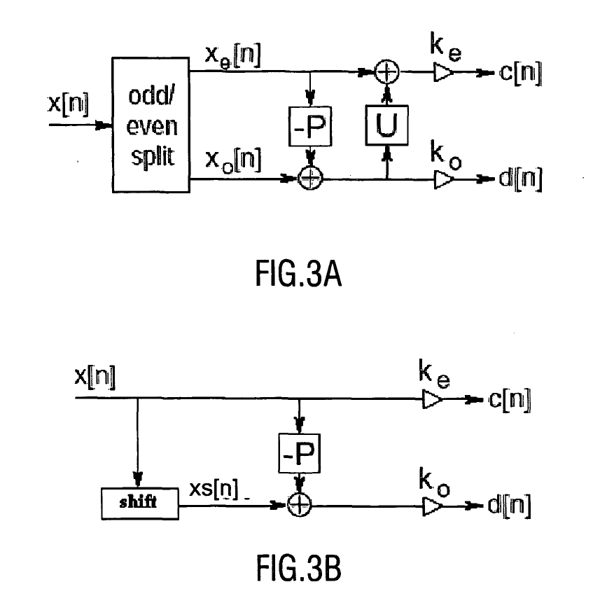

According to an embodiment of the invention, the step of constructing the LH, HL and HH subbands is implemented using a simplified lifting scheme. The conventional lifting scheme of a one-dimensional forward wavelet transform is depicted on FIG. 3A. According to said scheme, an input signal x contained in the original image is split into even xe[n] and odd xo[n] samples. During a prediction phase, the high-frequency wavelet coefficients d[n] are computed as follows:

d[n]=xo[n]−P(xe[n]), where P( ) is a prediction function.

During an update phase, the low-frequency wavelet coefficients c[n] are computed as follows: c[n]=xe[n]+U(d[n]), where U( ) is an update function. Resolutions of c[n] and d[n] are twice smaller than the one of x[n] due to the operation of odd/even split.

Because the up-scaling method does not implement a complete forward wavelet transform and the input signal x[n] already represents the low-frequency coefficients c[n], said up-scaling method is adapted to calculate the high-frequency wavelet coefficients d[n] and to normalize the low-frequency wavelet coefficients c[n]. Therefore, the operation of update U( ) is not required. Besides, the up-scaling should not implement the spliting of the input signal into sequences of even and odd samples, because the high-frequency wavelet coefficients d[n] are delivered with the same resolution as the input signal. The proposed simplified lifting scheme is depicted in FIG. 3B. According to said scheme, input samples x(n) are shifted, resulting in shifted samples xs(n). The high-frequency wavelet coefficients d[n] are computed on the basis of the input and shifted samples thanks to the prediction function as follows: d[n]=ko.(xs[n]−P(x[n])), whereas the low-frequency wavelet coefficients c[n] are derived from the input samples as follows: c[n]=ke.x [n], where ke and ko are normalization factors.

It would be apparent to a person skilled in the art that the high-pass filter of the construction step can be derived from the filters of the inverse wavelet transform according to other different manners.

According to an embodiment of the invention, pixel values of the original image are normalized by a normalization factor, said normalization factor depending on coefficients (or taps) of the high-pass filter, which is chosen for prediction of subbands and for inverse wavelet transform IWT.

This normalization is required because the forward wavelet transform results in a low-low LL subband with coefficients having a different intensity value range than the one of a natural image. This intensity value range difference depends on the type of wavelet filters used. Thus, the normalization factor has to be defined based on the wavelet filters used for inverse wavelet transform. For example, if a 9/7 biorthogonal wavelet transform is used, then the value of the normalization factor is equal to the square of the sum of the low-pass filter coefficients. All pixels of the input frame, considered as a LL subband, have to be multiplyed by this normalization factor.

According to another embodiment of the invention, the construction step and the inverse wavelet transform step are iterated until a predetermined up-scaling factor is reached. Said up-scaling factor can thus vary from 2 until 2^{N} where N is an integer strictly higher than one.

The subbands low-high LH, high-low HL and high-high HH thus constructed contain direction dependent high-frequency information, which is predicted for up-scaling of the original image. Availability of this information will reduce the staircase artifacts, i.e. the so-called jagged lines, in the up-scaled image, said artifacts being typical for conventional up-sampling techniques.

The proposed invention finds its application in spatial up-scaling of still images or of sequence of video frames decoded by wavelet-based decoders. For example, a spatially scalable stream compressed by a wavelet-based coder may be divided into several layers, each of which providing different resolution level. These layers may comprise a base layer containing the down-scaled version of the image, i.e. the LL subband, while the enhancement layers provide data required for reconstruction of the image at higher resolutions, i.e. the HL, LH, HH subbands. In case the enhancement layers are not available at the decoder side, i.e. only the base layer is received by the decoder, then the original image may be reconstructed from the down-scaled version of the image decoded from the base layer using an up-scaling device implementing the up-scaling method in accordance with the invention.

According to an embodiment of the invention, the proposed spatial up-scaling device is incorporated into the wavelet-based decoder. Thus, it does not require any additional dedicated architecture blocks, as inverse wavelet transform is already utilized for the image decoding. Therefore prediction of the high-frequency subbands may be implemented without additional overhead.

It will be apparent to a person skilled in the art that the up-scaling device can also be incorporated into a displaying apparatus receiving the decoded video frames. The displaying apparatus is, for example, a television receiver or a personal computer.

The above-described application should not limit the scope of the invention. The proposed up-scaling method may also be used independently of wavelet-based encoding/decoding systems.

The up-scaling method in accordance with the invention can be implemented by means of items of hardware or software, or both. Said hardware or software items can be implemented in several manners, such as by means of wired electronic circuits or by means of an integrated circuit that is suitable programmed, respectively. The integrated circuit can be contained in a decoder, in a personal computer or in a television receiver for example. A set of instructions contained, for example, in a memory may cause the integrated circuit to carry out the different steps of the up-scaling method. The set of instructions may be loaded into the memory by reading a data carrier such as, for example, a disk. A service provider can also make the set of instructions available via a communication network such as, for example, the Internet.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A method for spatial up-scaling of an original video frame comprising p rows and q colums of pixels, where p and q are integers, said up-scaling method comprising the steps of:
high-pass filtering the original video frame, considered as a low-low spatial frequency subband (LL), in horizontal, vertical, and both directions, to construct high-low (HL), low-high (LH), and high-high (HH) virtual spatial frequency subbands comprising p rows and q colums of pixels, respectively,
applying an inverse wavelet transform (IWT) to the constructed subbands and to the original video frame so that an up-sampled version of the original image is obtained.

2. A method as claimed in claim 1, wherein the high-pass filter that is used for the construction step is derived from a low-pass filter used for the inverse wavelet transform.

3. A method as claimed in claim 1, comprising a step of normalizing the pixel values of the original video frame by a normalization factor before the construction step, said normalization factor being derived from coefficients of the inverse wavelet transform filters.

4. A method as claimed in claim 1, wherein the step of constructing the high-frequency subbands comprises a sub-step of shifting input samples of the original video frame, a sub-step of predicting samples from the input samples using a prediction function, and a sub-step of computing high-frequency coefficients of a subband on the basis of the shifted samples and of the predicted samples.

5. A method as claimed in claim 1, wherein the step of constructing the high-high spatial frequency subband is adapted to use a null filter, resulting in a subband filled with zeros.

6. A method as claimed in claim 1, wherein the construction step and the inverse wavelet transform step are iterated until a predetermined up-scaling factor is reached.

7. A device for spatial up-scaling of an original video frame comprising p rows and q colums of pixels, where p and q are integers, said up-scaling device comprising:
means for high-pass filtering the original video frame, considered as a low-low spatial frequency subband (LL), in horizontal, vertical, and both directions, in order to construct high-low (HL), low-high (LH), and high-high (HH) spatial frequency subbands comprising p rows and q colums of pixels, respectively,
means for performing an inverse wavelet transform (IWT) on the constructed subbands and on the original video frame so that an up-sampled version of the original image is obtained.

8. An apparatus for displaying video frames, said apparatus comprising an up-scaling device as claimed in claim 7, which is adapted to provide an up-scaled video frame from an input video frame received by said apparatus.

9. A video decoding device for producing an output stream comprising decoded video frames from an input stream comprising encoded video frames, said decoding device comprising an up-scaling device as claimed in claim 7, which is adapted to provide an up-scaled video frame from a decoded video frame.

10. A computer program product comprising program instructions for implementing, when said program is executed by a processor, a method as claimed in claim 1.
